(19) United States
(12) Patent Application Publication
(10) Pub. No.: US 2002/0157111 A1
(43) Pub. Date: Oct. 24, 2002

(54) Television program-related coupon hyperlink system

(76) Inventor: David Anthony Reams, Toledo, OH (US)

Correspondence Address: David A. Reams, Unit 312, 2200 Scottwood Avenue, Toledo, OH, 43620, US

(21) Appl. No.: 09/839,074

(22) Filed: Apr. 20, 2001

(51) Int. Cl. H04N 7/173; G06F 15/16

(52) U.S. Cl. 725/112; 725/109; 709/217

(57) ABSTRACT

A system for generating an URL string including an URL to a web page having at least one coupon related to a video or audio program and text identifying the at least one coupon related to the program and activating an URL hyperlink to the web page having the at least one coupon related to the program comprises a data entering device for entering the URL to the web page having the at least one coupon related to the program, a generator for generating the URL string including the URL to the web page having the at least one coupon related to the program and the text identifying the at least one coupon related to the program, a program signal transmitter for transmitting the URL string to a program signal receiver, the program signal receiver for receiving the URL string, a display device for displaying the text identifying the at least one coupon related to the program, an activator for activating the URL hyperlink to the web page having the at least one coupon related to the program and, optionally, a printer for printing the at least one coupon related to the program from the web page.

### FIELD OF THE INVENTION

The invention relates to the field of distribution of coupons associated with a video or audio program. In particular, the invention relates to the field of using the Internet to distribute coupons associated with a video or audio program.

### BACKGROUND OF THE INVENTION

Vendors advertising in newspapers often provide coupons on merchandise for sale as enticements to draw members of the public into retail outlets. Said vendors, advertising or otherwise marketing merchandise in video or audio programs, may electronically distribute coupons via the program signals. Several prior art systems teach distributing coupons via interactive television. See, for example, Nemirofsky, U.S. Pat. No. 5,907,350, Jones, et al, U.S. Pat. No. 5,978,013, Walkingshaw, et al, U.S. Pat. No. 5,488,423 and Mankovitz, et al, U.S. Pat. No. 5,523,794, which are incorporated herein by reference. Said prior art systems, however, fail to provide efficient means for said vendors to enter and/or transmit program-related coupon information. By transmitting the entire coupon itself via the television signal rather than, for example, just the URL to a web page to access the coupon, said prior art systems necessitate higher bandwidth or television data capacity to transmit and thereby incur greater cost.

Further, said prior art systems do not combine vendor coupon information entry and interactive television with the Internet to assist in entering and distributing coupon information. As demonstrated herein, web technology can facilitate such coupon information entry and distribution. Thus, the problem with the prior art is twofold: excessive television data capacity and failure to employ the Internet to enhance vendor entry and distribution of program-related coupon information.

### SUMMARY AND OBJECTS OF THE INVENTION

The instant invention solves said twofold problem in prior art systems first by transmitting via the video or audio program signal the URL to a web page having a coupon rather than the entire coupon itself. Second, the instant invention brings the vast resources of the World Wide Web to facilitate vendor entry of program-related coupon information and integrates program-related URL receiving with Internet access to hyperlink to a coupon web page. The term “coupon” is defined herein expansively as in Engel, et al, U.S. Pat. No. 5,907,830, which is incorporated herein by reference, to include any paper certificate used to obtain anything of interest to a potential consumer such as special pricing, a discount, money, samples or additional product, premiums, rebates or any other thing of value or interest.

One object of the invention is to transmit a coupon web page URL address rather than the coupon itself with a program signal.

Another object of the invention is to use the Internet to enhance coupon information entry and distribution in interactive television/radio systems.

A related object of the invention is to deploy a website for vendor entry of program-related coupon information and generating a coupon URL string.

Yet another object of the invention is to connect television viewers and radio listeners to a web page to access a program-related coupon.

Additional objects will be apparent from the following detailed description.

### DETAILED DESCRIPTION OF THE INVENTION

### I. Website

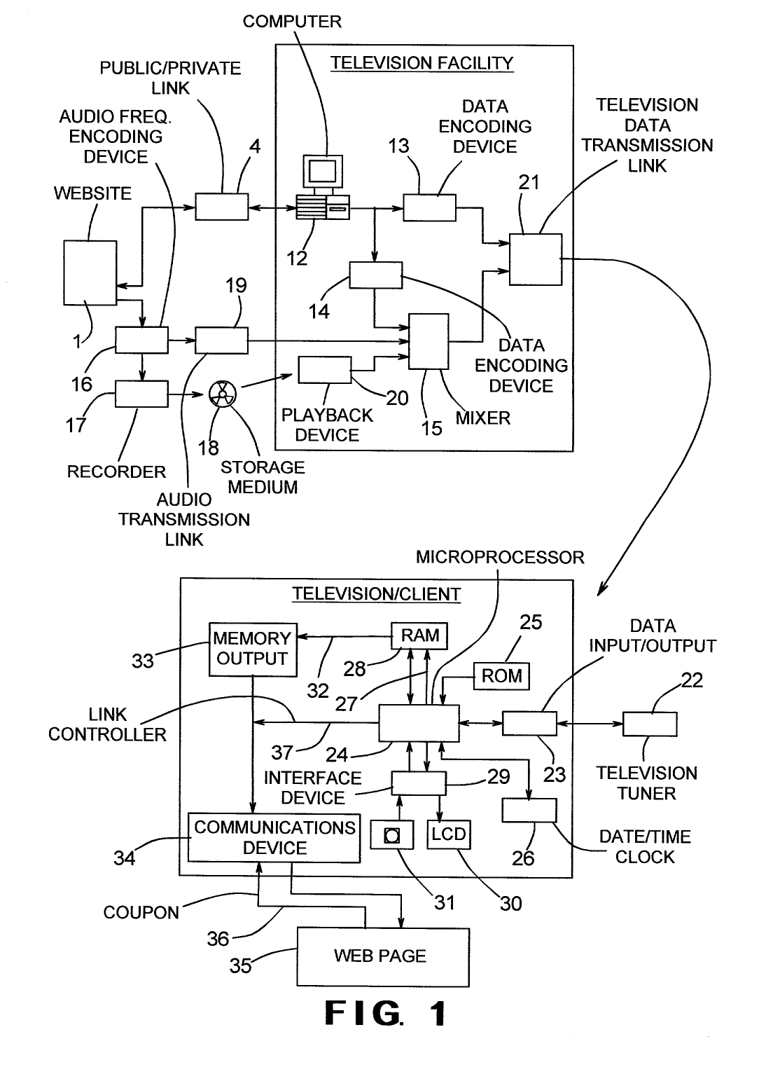

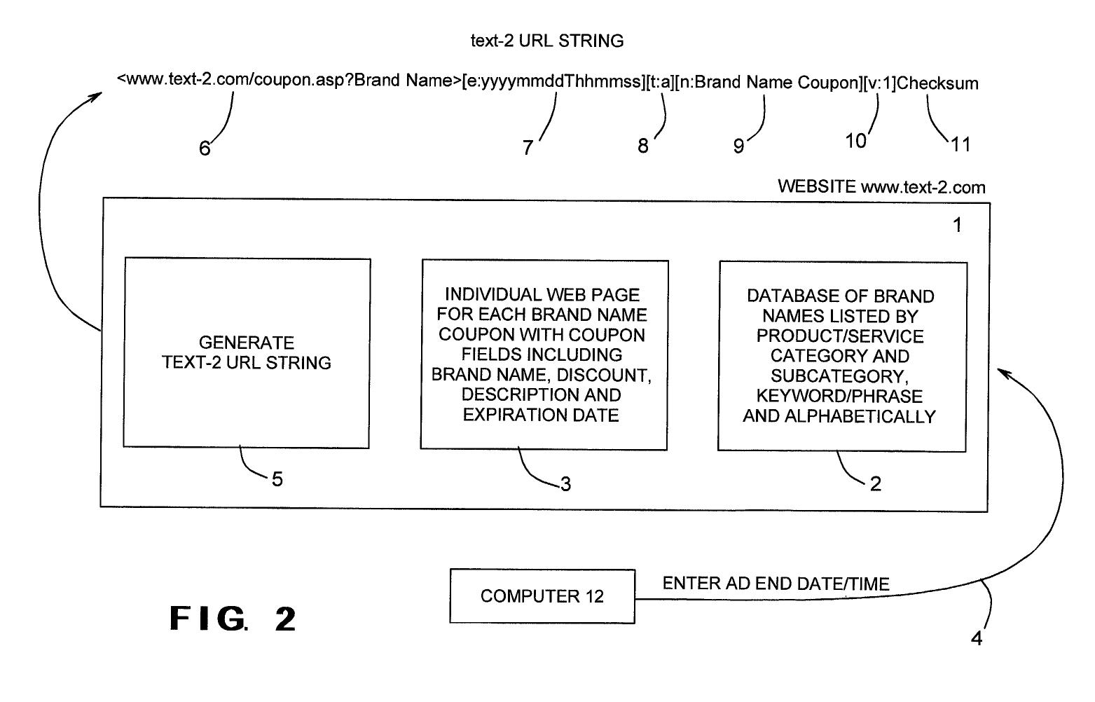

Referring to the Drawing FIG. 2, TELEVISION FACILITY COMPUTER 12 may access WEBSITE 1 via PUBLIC/PRIVATE LINK 4, which may be the public switched telephone network, an integrated digital network or similar wire or wireless facility, to encode an advertisement with an URL string including an URL to a web page having at least one coupon related to said advertisement and text identifying said at least one coupon. While the Drawing and system description herein are substantially specific to television facilities, it is understood that such specification is for illustrative purposes only and the Drawing and system description apply equally to broadcast, cable, satellite and Internet television and radio facilities and any video or audio recording medium.

Initially upon accessing WEBSITE 1 TELEVISION FACILITY may enter as date/time attribute 7 the end date/time for said advertisement to indicate when said URL will no longer be valid. In addition to encouraging viewers/listeners to return to video/audio programming after an advertisement-related coupon hyperlink, setting date/time attribute 7 to the advertisement end date/time effectively limits one coupon per viewer/listener due to practical time limitations after printing a first coupon off WEB PAGE 35.

Next, via WEBSITE 1 data entering means TELEVISION FACILITY may search DATABASE 2 of brand names and associated URLs to coupon web pages (each located as INDIVIDUAL WEB PAGE 3 at WEBSITE 1 or at the brand name website) to select a brand name scheduled to be advertised in said advertisement. Said brand names and associated URLs may be listed in DATABASE 2 by product/service category and subcategory, key word/phrase and alphabetically. When a brand name is selected, the associated URL to the web page having at least one brand name coupon may be automatically entered in said URL string and the text “[Brand Name] Coupon”, using the selected brand name, may be automatically generated in said URL string as said text identifying said at least one coupon related to said advertisement. TELEVISION FACILITY may alternatively directly enter via said data entering means a brand name of interest and/or an associated URL to a web page having at least one brand name coupon and said text identifying said at least one coupon related to said advertisement without selecting said brand name from DATABASE 2.

Said URL string may be generated for VBI, Line 21 (“Transport Type A”) and resource data and trigger (“Transport Type B”)transmission using the EIA-746A standard as specified in w w w.atvef.com/library/slec1_{—}1a.html, which is incorporated herein by reference. Said EIA-746A standard provides both television operators and receiver manufacturers a common means for delivering URLs associated with a commercial or other program, using the same television transmit channel used for closed captioning, thereby making said URLs available virtually everywhere television programming is received and enabling the use of closed captioning tools to encode and broadcast the URLs. The system disclosed herein supports both Transport Type A and Transport Type B triggers.

Via generating means WEBSITE 1 may generate 5 an URL string including said selected URL, <w w w.text-2.com/coupon.asp?Brand Name>6, the entered date/time attribute, [e:yyymmddThhmmss] 7 to indicate the ending date (on the left side of “T”) and time (on the right side of “T”) that the URL associated with said advertisement is to be valid - for example, the advertisement end date/time, and [n:Brand Name Coupon] 9 to display as text identifying said at least one coupon to prompt a viewer or listener to activate a program-related URL 6 hyperlink to coupon WEB PAGE 35. Optionally, said URL string may further comprise [t:a] 8 indicating the program type is an advertisement, [v:1] 10 indicating the URL content is ATVEF compliant and a checksum 11 for error detection/correction. Additional attributes that may be coded in said URL string include [s:string] (NOT SHOWN), a script attribute, [auto:true] (NOT SHOWN) for WebTV™ Receiver to automatically load an interactive television link, [showPIP:true] (NOT SHOWN) so a picture-in-picture video appears in a target web page on WebTV™ Receiver and [time:yyyymmddThhmmss] (NOT SHOWN), an hyperlink start date/time attribute detected by WebTV™ Receiver.

In one preferred embodiment disclosed herein said data entering means and generating means may comprise website means. Alternatively, said data entering means and generating means may comprise computer means i.e. COMPUTER 12. WEBSITE 1 may then output said URL string to either AUDIO FREQUENCY ENCODING DEVICE 16 to encode said URL string for transmission via program audio channel data transmission means or download said URL string to program signal transmitting means. AUDIO FREQUENCY ENCODING DEVICE 16 may inaudibly embed said URL string in the program audio itself. Audio frequency encoded data signals may then be fed from AUDIO FREQUENCY ENCODING DEVICE 16 to RECORDER 17 and onto STORAGE MEDIUM 18, or, alternatively, sent through AUDIO TRANSMISSION LINK 19 (such as a network program distribution system) to MIXER 15 located at TELEVISION FACILITY to be mixed in with program audio signals. STORAGE MEDIUM 18 may be sent to TELEVISION FACILITY for later playback via PLAYBACK DEVICE 20. Said URL string may be downloaded via PUBLIC/PRIVATE LINK 4 to TELEVISION FACILITY to be processed and transmitted via TELEVISION DATA TRANSMISSION LINK 21 at appropriate times in conjunction with transmission of associated program signals. Downloaded via PUBLIC/PRIVATE LINK 4, COMPUTER 12 may then output said URL string to DATA ENCODING DEVICE 13 to encode said URL string for transmission via conventional program data channel means such as VBI, MPEG, subcarrier, etc. In the alternative, COMPUTER 12 may output said URL string to DATA ENCODING DEVICE 14 to encode said URL string for transmission via program audio channel means (i.e. embedding in program audio signals via MIXER 15). In one preferred embodiment herein said URL string for television programs may be encoded for transmission via VBI, Line 21 pursuant to said EIA-746A standard.

Website including HTML code demonstrating one embodiment of said system website means is provided below in Appendix, which is incorporated by reference. Specifically, Appendix demonstrates, respectively, WEBSITE 1 data entering means searching by product/service category and subcategory, key word or phrase and alphabetically and selecting a brand name for an associated brand name coupon web page URL to be entered (3 pages of code, 11-13) and entering program-related date/time attributes (5 pages of code,14-l 8) and WEBSITE 1 generating means generating the URL string (29 pages of code, 19-47).

### II. Apparatus

The apparatus claimed herein is tied to and dependant upon said data entering means and generating means. Indeed, said apparatus is dependant on said data entering and generating means to receive a program-related coupon web page URL and text identifying the program-related coupon.

Referring to the Drawing, TELEVISION TUNER 22 may receive said URL string transmitted via TELEVISION DATA TRANSMISSION LINK 21. Said program signal receiving means may comprise any video or audio program receiver means such as broadcast, cable or satellite television or radio tuner means, the WebTV™ Internet Terminal available from Microsoft Corporation, Redmond, Wash. or WebTV Networks Inc., Palo Alto, Calif., set-top box means, Internet program signal receiver means or other program signal receiver means. In another embodiment, said program signal receiving means may comprise storage medium means such as video or audio recorder or player means.

Via DATA INPUT/OUTPUT 23, said URL string may be input to MICROPROCESSOR 24 (which may comprise any conventional data processor, microprocessor, central processing unit or equivalent data processing means). ROM 25 may store the program of instructions which controls MICROPROCESSOR 24. MICROPROCESSOR 24 may then route URL 6 via BUS 27 to be temporarily stored in RAM 28, route [n:Brand Name Coupon] 9 via INTERFACE DEVICE 29 to be displayed as non-hypertext or, optionally, “hyperlink text” via LCD 30 and detect the URL expiration date/time from [e:yyyymmddThhmmss] 7, the type of Internet content URL 6 is associated with from [t:a] 8 (an advertising sponsor) and that the associated Internet content is ATVEF compliant from [v:1] 10. The term “hyperlink text” as used herein encompasses the meaning including hypertext conferred thereon in Boden, et al, U.S. Pat. No. 5,930,512, Nielsen, U.S. Pat. No. 6,199,071, Carroll, et al, U.S. Pat. No. 6,154,205 and Kato, U.S. Pat. No. 5,809,512, which are incorporated herein by reference.

In one preferred embodiment date/time attribute 7 may be detected and compared by comparing means with current date/time information from DATE/TIME CLOCK 26 first before one or more other attributes in said URL string is processed to ascertain first if said URL remains valid DATE/TIME CLOCK 26 and/or said comparing means may be remote from or built-into said apparatus such as disclosed in Danneels, U.S. Pat. No. 5,602,992 or Maturi, et al, U.S. Pat. No. 5,559,999, which are incorporated herein by reference.

Hyperlink to WEB PAGE 35 may be user activated via PUSHBUTTON 31. Visual display means such as LCD 30 may be used to alert an user that user activation of said hyperlink is available to be made. LCD 30, for example, may visually display “[Brand Name] Coupon” as text or, optionally, hypertext from [n:Brand Name Coupon] 9 to inform viewers that an hyperlink to coupon WEB PAGE 35 is available. In the WebTV™ Internet Terminal embodiment disclosed herein LCD 30 may comprise a drop down panel that displays said text. Date/time attribute 7, in addition to indicating when program-related URL 6 is no longer valid, may specify a stop display time as well so that said display coincides with the time when coupon WEB PAGE 35 is available to be accessed.

LED or equivalent visual display means rather than LCD 30 may be used as said visual display means. In addition, user activation means other than PUSHBUTTON 31 may be used such as keypad or VRU. Activating PUSHBUTTON 31, directly or via remote control, may send a control signal to MICROPROCESSOR 24, which, in turn, may instruct RAM 28 to output the stored URL 6 via BUS 32 to MEMORY OUTPUT 33.

Both LCD 30 and PUSHBUTTON 31 may be built into a conventional remote control unit, such as that disclosed in Yazolino, et al, U.S. Pat. No. 5,329,379, which is incorporated herein by reference, and communicably coupled to MICROPROCESSOR 24. INTERFACE DEVICE 29 may then connect to a conventional two-way infrared (IR) link coupled to said remote control unit to send and receive control signals.

Upon said activation an hyperlink to WEB PAGE 35 may be established via TELEVISION/CLIENT BROWSER (NOT SHOWN). COUPON 36 may then be printed, optionally without user activation pursuant to, for example, an HTML instruction included in said URL string, via WebTV m PRINTER (NOT SHOWN) at COMMUNICATIONS DEVICE 34. In another embodiment disclosed herein a SMART CARD (NOT SHOWN) as disclosed in Britt, Jr., U.S. Pat. No. 6,141,678, White, et al, U.S. Pat. No. 4,119,114 and Nemirofsky, U.S. Pat. No. 5,907,350, which are incorporated herein by reference, may be coupled to COMMUNICATIONS DEVICE 34 to receive redeemable coupons.

LINK CONTROLLER 37 may serve as an hyperlink de-activator. For example, LINK CONTROLLER 37 may automatically de-activate an advertisement-related hyperlink to an advertising brand name coupon WEB PAGE 35 when the advertisement ends, e.g. the date/time specified by URL date/time attribute 7. In said embodiment [e:yyymmddThhmmss] 7 may reference an automatic hyperlink de-activate HTML instruction. In one embodiment herein said hyperlink may be de-activated via LINK CONTROLLER 37 as the WebTV™ client disclosed in Perlman, et al, U.S. Pat. No. 5,896,444, which is incorporated herein by reference, terminates communication with a server. Clearly, numerous modifications and variations of the instant invention are possible in light of the above teachings. It is therefore understood that, within the scope and spirit of the claims made herein, the invention may be practiced otherwise than as specifically described herein and the invention may be modified in arrangement and detail without departing from such scope and spirit.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

I claim:

1. A system for generating an URL string including an URL to a web page having at least one coupon related to a program and text identifying said at least one coupon related to said program and activating an URL hyperlink to said web page having said at least one coupon related to said program comprising:
data entering means for entering said URL to said web page having said at least one coupon related to said program;
generating means for generating said URL string including said URL to said web page having said at least one coupon related to said program and said text identifying said at least one coupon related to said program;
program signal transmitting means for transmitting said URL string to program signal receiving means;
said program signal receiving means for receiving said URL string;
display means for displaying said text identifying said at least one coupon related to said program and
activating means for activating said URL hyperlink to said web page having said at least one coupon related to said program.

2. A system according to claim 1 further comprising:
printing means for printing said at least one coupon from said web page.

3. A method for generating an URL string including an URL to a web page having at least one coupon related to a program and text identifying said at least one coupon related to said program comprising the steps of:
entering via data entering means said URL to said web page having said at least one coupon related to said program and
generating via generating means said URL string including said URL to said web page having said at least one coupon related to said program and said text identifying said at least one coupon related to said program.

4. A method according to claim 3 wherein
said program comprises an advertisement.

5. A method according to claim 3 wherein
said entering via said data entering means comprises selecting from a database of brand names and associated URLs to web pages having respective one or more brand name coupons a brand name of interest whereupon
the URL associated with the selected brand name is automatically entered via said data entering means.

6. A method according to claim 3 wherein
said entering via said data entering means comprises selecting from a database of brand names and associated URLs to web pages having respective one or more brand name coupons a brand name of interest whereupon
“[Brand Name] Coupon” is automatically generated as said text identifying said at least one coupon related to said program.

7. A method according to claim 3 wherein
said data entering means and generating means comprise website means.

8. A method according to claim 3 wherein
said URL string further includes a date/time attribute specifying expiration date and/or time information for said URL to said web page.

9. A method according to claim 3 wherein
said URL string further includes at least one URL or HTML instruction.

10. A method according to claim 3 wherein
said text identifying said at least one coupon related to said program comprises hyperlink text.

11. A method according to claim 3 further comprising the step of:
downloading said URL string to program signal transmitting means for transmitting said URL string to program signal receiving means.

12. An apparatus having program signal receiving means for receiving program signals, display means for displaying text and activating means for activating an hyperlink to a program-related URL comprising:
said program signal receiving means for receiving an URL string including an URL to a web page having at least one coupon related to a program and text identifying said at least one coupon related to said program;
said display means for displaying said text identifying said at least one coupon related to said program and
said activating means for activating said hyperlink to said URL to said web page having said at least one coupon related to said program.

13. An apparatus according to claim 12 wherein
said program comprises a video program.

14. An apparatus according to claim 12 wherein
said program comprises an audio program.

15. An apparatus according to claim 12 wherein
said program signal receiving means comprises tuner means.

16. An apparatus according to claim 12 wherein
said program signal receiving means for receiving said URL string comprises VBI, Line 21 receiving means.

17. An apparatus according to claim 12 wherein
said program signal receiving means comprises storage medium means.

18. An apparatus according to claim 12 wherein
said display means comprises hypertext display means for displaying said text identifying said at least one coupon related to said program as hypertext.

19. An apparatus according to claim 12 wherein
said URL string further includes a date/time attribute specifying the date and/or time said URL to said web page having said at least one coupon related to said program expires and
said display means further comprises means for displaying said text identifying said at least one coupon related to said program until the expiration date and/or time specified by said date/time attribute.

20. An apparatus according to claim 12 further comprising:
printing means for printing said at least one coupon related to said program from said web page.
